(19) United States
(12) Patent Application Publication
(10) Pub. No.: US 2012/0166335 A1
(43) Pub. Date: Jun. 28, 2012

(54) TRANSACTION INTEGRITY

(76) Inventors: Sanjay Bakshi, Portland, OR (US); Kumar Ranganathan, Bangalore (IN); Vinay Phegade, Beaverton, OR (US)

(21) Appl. No.: 13/053,481

(22) Filed: Mar. 22, 2011

(30) Foreign Application Priority Data
Dec. 23, 2010 (IN) 3084/DEL/2010

(51) Int. Cl. G06Q 40/00

(52) U.S. Cl. 705/44

(57) ABSTRACT

In one embodiment a secure controller comprises a memory module, and logic to receive one or more information components pertaining to a transaction initiated by a user on a controller separate from the secure controller, present, on a display device, a Turing test in combination with one or more information components associated with the transaction, receive a user input in response to the Turing test, authenticate the transaction when the user input corresponds to the answer to the Turing test and the personal identifier matches a personal identifier associated with the user. Other embodiments may be described.

### PRIORITY APPLICATION

This application claims the benefit of priority under 35 U.S.C. §119 to application number 3084/DEL/2010, filed in India on Dec. 23, 2010, the entire disclosure of which is incorporated herein by reference.

### BACKGROUND

The subject matter described herein relates generally to the field of electronic devices and more particularly to a system and method to implement transaction integrity using electronic devices.

In a typical electronic commerce transaction the merchant (and underlying ecosystem), is not certain that the individual conducting the transaction is the authorized person. When fraudulent transactions are accepted by the online ecosystem there is an underlying fraud cost that is generally borne by the relying party, in this example the merchant, or by the defrauded individual.

Another weakness in the online space is the ever-present threat of system malware, which is often used to steal personal information, including payment credentials, for use by unauthorized individuals. This threat has an effect on a certain percentage of the population who will not conduct online activity due to fear of having their information compromised. This reduces efficiencies that can be gained through online commerce and limits the amount of goods and services purchased by concerned individuals, limiting the growth of online commerce.

Existing solutions to these problems are limited in their usefulness and/or security due to the fact that they are hosted inside the PC operating system, which is always a point of vulnerability, or require external, attached hardware devices, which limit consumer ease-of-use factors. Accordingly systems and techniques to provide a secure computing environment for electronic commerce may find utility.

### BRIEF DESCRIPTION OF THE DRAWINGS

The detailed description is described with reference to the accompanying figures.

FIG. 1 is a schematic illustration of an exemplary electronic device which may be adapted to include infrastructure for transaction integrity in accordance with some embodiments.

FIG. 2 is a high-level schematic illustration of an exemplary architecture for transaction integrity in accordance with some embodiments.

FIG. 3 is a flowchart illustrating operations in a method to implement transaction integrity in accordance with some embodiments.

FIG. 4 is a schematic illustration of an electronic device which may be adapted to implement client hardware authenticated transactions accordance with some embodiments.

### DETAILED DESCRIPTION

Described herein are exemplary systems and methods to implement transaction integrity in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

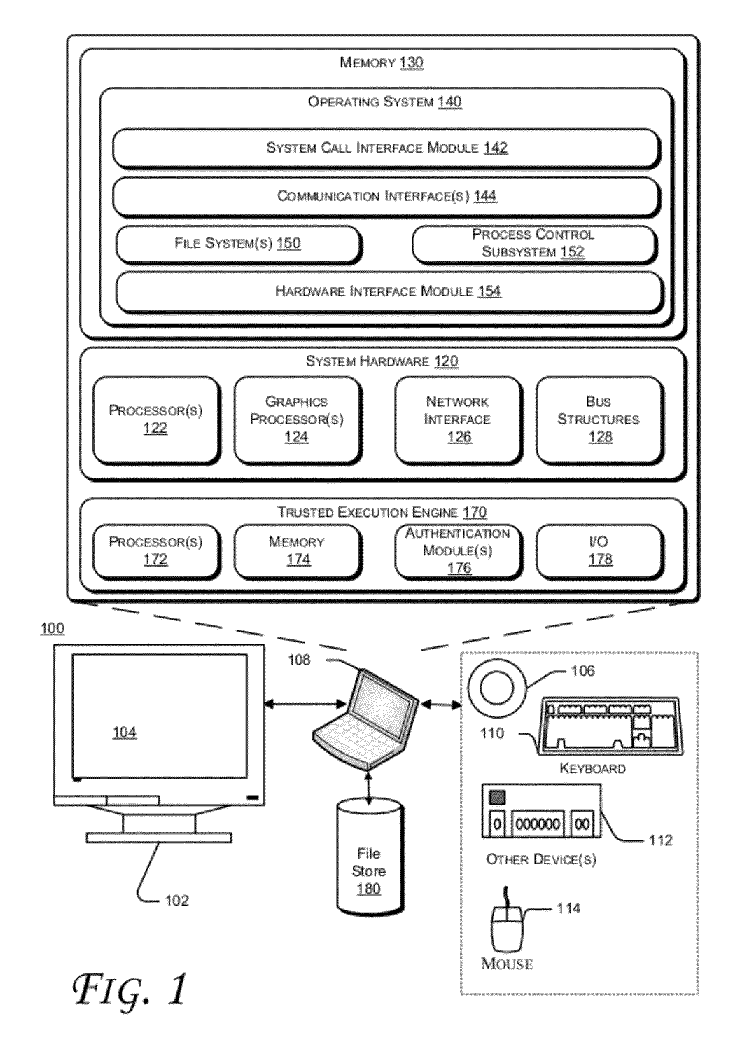

FIG. 1 is a schematic illustration of an exemplary system 100 which may be adapted to implement transaction integrity in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, a geolocation device, an accelerometer/gyroscope and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel ® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated into the packaging of processor(s) 122, onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN--Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

In some embodiments system 100 may comprise a low-power embedded processor, referred to herein as a trusted execution engine 170. The trusted execution engine 170 may be implemented as an independent integrated circuit located on the motherboard of the system 100. In the embodiment depicted in FIG. 1 the trusted execution engine 170 comprises a processor 172, a memory module 174, an authentication module 176, and an I/O module 178. In some embodiments the memory module 164 may comprise a persistent flash memory module and the authentication module 174 may be implemented as logic instructions encoded in the persistent memory module, e.g., firmware or software. The I/O module 178 may comprise a serial I/O module or a parallel I/O module. Because the trusted execution engine 170 is physically separate from the main processor(s) 122 and operating system 140, the trusted execution engine 170 may be made secure, i.e., inaccessible to hackers such that it cannot be tampered with.

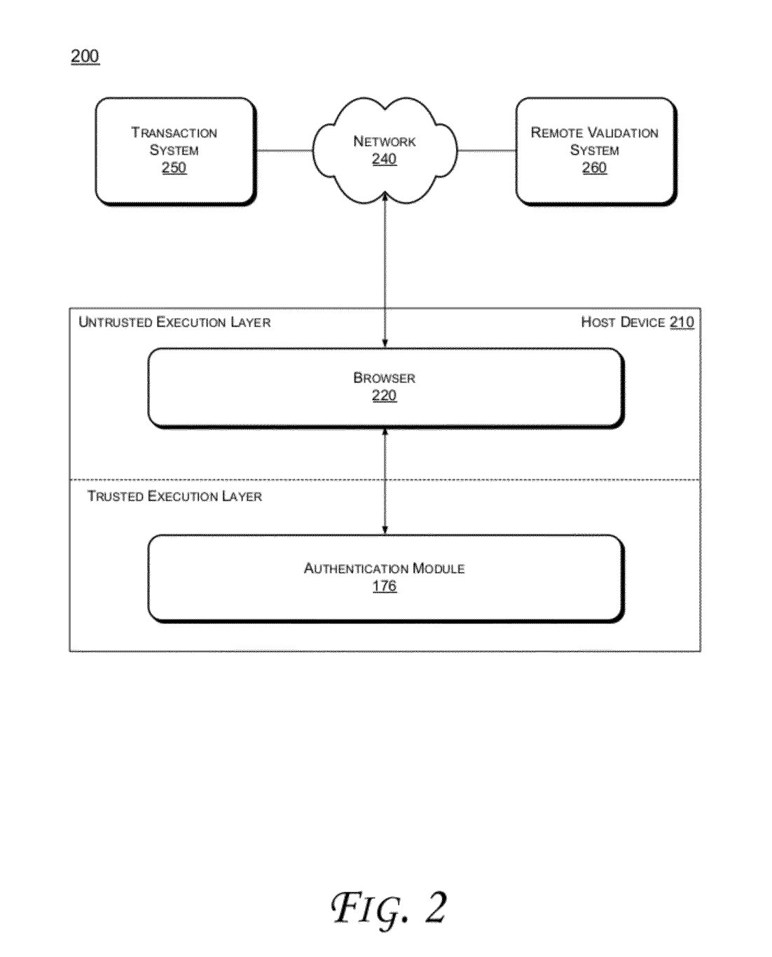

In some embodiments the trusted execution engine may be used to ensure transaction integrity for one or more transactions between a host electronic device and a remote computing device, e.g., a online commerce site or the like. FIG. 2 is a high-level schematic illustration of an exemplary architecture for transaction integrity accordance with some embodiments. Referring to FIG. 2, a host device 210 may be characterized as having an untrusted execution layer and a trusted execution layer. When the host device 210 is embodied as a system 100 the trusted execution layer may be implemented by the trusted execution engine 170, while the untrusted execution layer may be implemented by the main processors(s) 122 and operating system 140 of the system 100. In some embodiments the trusted execution layer may be implemented in a secure portion of the main processor(s) 122. As illustrated in FIG. 2, remote entities that originate transactions, identified as a transaction system in FIG. 2, may be embodied as electronic commerce websites or the like and may be coupled to the host device via a communication network 240. In use, an owner or operator of electronic device 108 may access the transaction system 250 using a browser 220 via the network and initiate an electronic commerce transaction on the system 250. The authentication module 176, alone or in combination with a remote validation system 260 may implement procedures to authenticate the transaction.

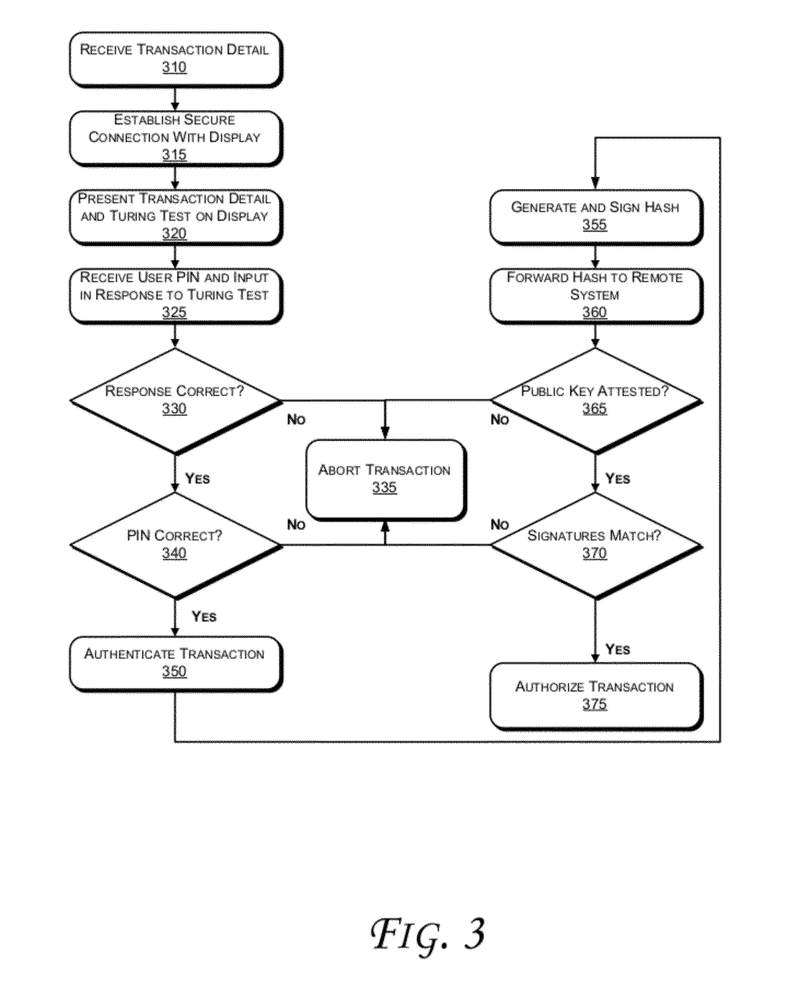

Having described various structures of a system to implement transaction integrity, operating aspects of a system will be explained with reference to FIG. 3, which is a flowchart illustrating operations in a method to implement transaction integrity in accordance with some embodiments. In some embodiments the operations depicted in the flowchart of FIG. 3 may be implemented by the authentication module(s) 176 of the trusted execution engine 170.

Referring to FIG. 3, at operation 310 the authentication module 176 receives a transaction detail for one or more transactions initiated by the electronic device 108. By way of example, the transaction may be initiated with an electronic commerce website or other transaction system by a user of the electronic device 108. The specifics of the transaction are not critical.

At operation 315 the authentication module 176 causes the trusted execution engine 170 to establish a secure connection with at least a portion of the display 104 on or coupled to the electronic device 108. In some embodiments the trusted execution engine 170 may establish a secure communication channel with a graphics hub in the electronic device 108.

At operation 320 the authentication module 176 presents a transaction detail and a reverse Turing test on at least the portion of the display with which a communication connection has been established, and at operation 325 the authentication module 176 receives a user personal identification number (PIN) and a response to the reverse Turing test presented on the display. Multiple different embodiments of implementing operations 320 and 325 are envisioned, and may be implemented alone or in combination. As used herein, the phrase “reverse Turing test” refers to a test which has as its objective to distinguish between a machine input and a human input. By way of example, a CAPTCHA (Completely Automated Public Turing Test to tell Computers and Humans Apart) test is one form of a reverse Turing test. Other examples of reverse Turing tests comprise a “fly on the wall test” a pattern recognition test, a color recognition test, and the like. One skilled in the art will recognize that while these tests are reverse Turing tests, many references and sources in the art omit the phrase “reverse” and refer to them generally as Turing tests. As used herein, the phrase “Turing test” should be construed to cover either a conventional Turing test or a reverse Turing test.

In a first embodiment the authentication module 176 generates and displays a high-entropy randomized or pseudo-randomized virtual alphanumeric keyboard on a portion of the display with which a communication channel has been established. The authentication module 176 then presents a sequence of characters for the user to select on the keyboard, and detects one or more mouse clicks in response to the sequence of characters. By way of example, a sequence of characters may be highlighted on the virtual keyboard and the user may have to click on the virtual keys as they are highlighted. The location of the mouse clicks may be detected, either directly by the authentication module or an application running under the operating system 140, which reports the location of the mouse clicks to the authentication module. The authentication module 176 may then determine whether the location of the mouse clicks corresponds to the correct alphanumeric keys. Advantageously, because the virtual keyboard is randomized it cannot be snooped by malware operating in the untrusted execution layer.

In a second embodiment the authentication module 176 may present a virtual, randomized keyboard as described in connection with the first embodiment, but may utilize touch screen functionality to determine whether the correct alphanumeric keys were selected. Again, because the virtual keyboard is randomized it cannot be snooped by malware operating in the untrusted execution layer.

In the first and second embodiments the keyboard presented by authentication module functions as a high-entropy CAPTCHA test. In a third embodiment the authentication module may present a more conventional CAPTCHA test. By way of example the CAPTCHA test may take the form of a series of alphanumeric characters which may or may not be distorted or a color palette from which a user is expected to select one or more specific colors or a series of images from which a user is expected to select one or more images. One skilled in the art will recognize that other authentication techniques may be implemented.

At operation 330 it is determined whether the response given to the CAPTCHA test was correct. If, at operation 330, the response to the Turing test was not correct then control passes to operation 335 and the transaction is aborted. One skilled in the art will recognize that the user may be given multiple chances to try to successfully respond to a Turing test. Thus, in some embodiments control may pass back to operation 320 one or more time when the response to the turing test is incorrect. In any event, after a predetermined number of failures the transaction may be aborted. In this circumstance a failure indictor may be presented on a user interface of the electronic device 108. By way of example a failure message may be presented on the display 104 of the device or an audible failure indicator may be presented on the speaker 106.

By contrast, if at operation 330 the response is correct then control passes to operation 340, where it is determined whether the PIN entered by the user matches a prestored PIN associated with the user. In some embodiments the PIN may be set by a user of the system or may be obtained from a remote source, e.g., a website or the like.

If at operation 340 the PIN number is not correct then again control passes to operation 335 and the transaction is aborted. Again, one skilled in the art will recognize that the user may be given multiple chances to try to successfully enter a PIN. Thus, in some embodiments control may pass back to operation 320 one or more time when the response to the Turingtest is incorrect. In any event, after a predetermined number of failures the transaction may be aborted. In this circumstance a failure indictor may be presented on a user interface of the electronic device 108. By way of example a failure message may be presented on the display 104 of the device or an audible failure indicator may be presented on the speaker 106.

By contrast, if at operation 340 the PIN is correct then control passes to operation 350 and the transaction is authenticated. In some embodiments this may be sufficient to confirm that the transaction and user are authentic and the transaction may be allowed to proceed. In other embodiments a second level of authentication may be implemented in which the electronic device may be authenticated by a remote validation system 260 using cryptographic techniques.

In such embodiments control passes to operation 355 where the authentication module generates a hash of a representation of the transaction details and signs the representation using a public cryptography key preselected by the user. At operation 360 the signed has and its corresponding transaction representation are transmitted to the remote validation system 260, which verifies via an appropriate cryptographic key (e.g., a public key certificate) that the key used to sign the hash resides within the trusted execution engine 170.

If, at operation 365 the public key is cannot be attested then again control passes to operation 335 and the transaction is aborted. In this circumstance a failure indictor may be presented on a user interface of the electronic device 108. By way of example a failure message may be presented on the display 104 of the device or an audible failure indicator may be presented on the speaker 106.

By contrast, if at operation 365 the public key is attested then control passes to operation 370, where it is determined wither the signatures on the public key certificate and the transaction record match. If, at operation 370 the signatures do not match then again control passes to operation 335 and the transaction is aborted. In this circumstance a failure indictor may be presented on a user interface of the electronic device 108. By way of example a failure message may be presented on the display 104 of the device or an audible failure indicator may be presented on the speaker 106. By contrast, if at operation 370 the signatures match then control passes to operation 375 and the transaction may be authorized.

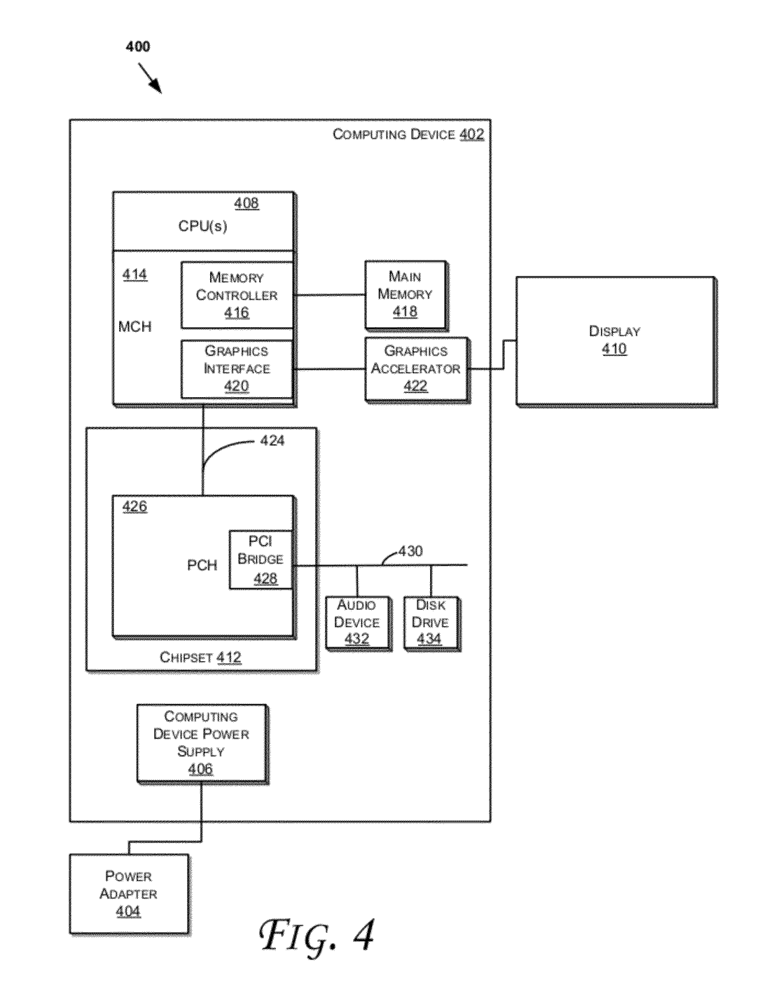

As described above, in some embodiments the electronic device may be embodied as a computer system. FIG. 4 is a schematic illustration of a computer system 400 in accordance with some embodiments. The computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In some embodiments, the power adapter 404 may transform the power supply source output (e.g., the AC outlet voltage of about 110VAC to 240VAC) to a direct current (DC) voltage ranging between about 7VDC to 12.6VDC. Accordingly, the power adapter 404 may be an AC/DC adapter.

The computing device 402 may also include one or more central processing unit(s) (CPUs) 408. In some embodiments, the CPU 408 may be one or more processors in the Pentium® family of processors including the Pentium® II processor family, Pentium® III processors, Pentium® IV , CORE2 Duo processors, or Atom processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 412 may be coupled to, or integrated with, CPU 408. The chipset 412 may include a memory control hub (MCH) 414. The MCH 414 may include a memory controller 416 that is coupled to a main system memory 418. The main system memory 418 stores data and sequences of instructions that are executed by the CPU 408, or any other device included in the system 400. In some embodiments, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

The MCH 414 may also include a graphics interface 420 coupled to a graphics accelerator 422. In some embodiments, the graphics interface 420 is coupled to the graphics accelerator 422 via an accelerated graphics port (AGP). In some embodiments, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to an platform control hub (PCH) 426. The PCH 426 provides an interface to input/output (I/O) devices coupled to the computer system 400. The PCH 426 may be coupled to a peripheral component interconnect (PCI) bus. Hence, the PCH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express™ architecture, available through Intel® Corporation of Santa Clara, Calif.

The PCI bus 430 may be coupled to an audio device 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in other embodiments.

Additionally, other peripherals coupled to the PCH 426 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 402 may include volatile and/or nonvolatile memory.

Thus, there is described herein an architecture and associated methods to implement transaction integrity in electronic devices. In some embodiments the architecture uses hardware capabilities embedded in an electronic device platform to provide assurances to transaction-authorizing parties that a transaction is being made by an authorized individual. In the embodiments described herein authentication and persistence are based processing that occurs within a trusted environment, separate from the host operating system. The execution environment may be implemented in a trusted execution engine, which obtains and verifies user identity, then provides proof of identity verification, and may provide other elements required to satisfy transaction requirements. The result is a platform-issued token that represents fulfillment of these required elements to relying parties. In some embodiments the trusted execution engine may be implemented in a remote device, e.g., a dongle,

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A secure controller, comprising logic to:
receive one or more information components pertaining to a transaction initiated by a user on a controller separate from the secure controller;
present, on a display device, a Turing test in combination with one or more information components associated with the transaction;
receive a user input in response to the Turing test;
authenticate the transaction when the user input corresponds to the answer to the Turing test and the personal identifier matches a personal identifier associated with the user.

2. The controller of claim 1, further comprising logic to:
generate and sign a hash of a representation of the transaction; and
send the signed hash to a software module executable on a processor separate from the secure controller.

3. The controller of claim 1, further comprising logic to:
receive a personal identifier from an input; and
authenticate the transaction when the personal identifier matches a personal identifier associated with the user.

4. The controller of claim 1, further comprising logic to:
establish a secure channel between the secure controller and at least a portion of the display device; and
generate and presents a keyboard on the portion of the display device;
present a sequence of characters for the user to select on the keyboard; and
detect one or more cursor positions in response to the sequence of characters.

5. The controller of claim 1, wherein the cursor position corresponds to an input from at least one of a mouse click, a touch pad, a keyboard, or a touch screen.

6. The controller of claim 1, further comprising logic to:
establish a secure channel between the secure controller and at least a portion of the display device; and
generate and present a keyboard on the portion of the display device;
present a sequence of characters for the user to select on the keyboard; and
detect one or more key strokes in response to the sequence of characters.

7. An electronic device, comprising:
a display;
a processor;
an operating system executable on the processor to implement an untrusted computing environment; and
a controller, comprising logic to:
receive one or more information components pertaining to a transaction initiated by a user on a controller separate from the secure controller;
present, on a display device, a Turing test in combination with one or more information components associated with the transaction;
receive a user input in response to the Turing test;
authenticate the transaction when the user input corresponds to the answer to the Turing test and the personal identifier matches a personal identifier associated with the user.

8. The electronic device of claim 7, further comprising logic to:
generate and sign a hash of a representation of the transaction; and
send the signed hash to a software module executable on a processor separate from the secure controller.

9. The electronic device of claim 7, further comprising logic to:
receive a personal identifier from an input; and
authenticate the transaction when the personal identifier matches a personal identifier associated with the user.

10. The electronic device of claim 7, further comprising logic to:
establish a secure channel between the secure controller and at least a portion of the display device; and
generate and presents a keyboard on the portion of the display device;
present a sequence of characters for the user to select on the keyboard; and
detect one or more cursor positions in response to the sequence of characters.

11. The electronic device of claim 10, wherein the cursor position corresponds to an input from at least one of a mouse click, a touch pad, a keyboard, or a touch screen.

12. The electronic device of claim 7, further comprising logic to:
establish a secure channel between the secure controller and at least a portion of the display device; and
generate and present a keyboard on the portion of the display device;
present a sequence of characters for the user to select on the keyboard; and
detect one or more key strokes in response to the sequence of characters.

13. A computer program product comprising logic instructions stored on a tangible computer readable medium which, when executed by a secure controller, configure the secure controller to:
receive one or more information components pertaining to a transaction initiated by a user on a controller separate from the secure controller;
present, on a display device, a Turing test in combination with one or more information components associated with the transaction;
receive a user input in response to the Turing test;
authenticate the transaction when the user input corresponds to the answer to the Turing test and the personal identifier matches a personal identifier associated with the user.

14. The computer program product of claim 13, further comprising logic instructions stored on a tangible computer readable medium which, when executed by a secure controller, configure the secure controller to:
generate and sign a hash of a representation of the transaction; and
send the signed hash to a software module executable on a processor separate from the secure controller.

15. The computer program product of claim 13, further comprising logic instructions stored on a tangible computer readable medium which, when executed by a secure controller, configure the secure controller to:
receive a personal identifier from an input; and
authenticate the transaction when the personal identifier matches a personal identifier associated with the user.

16. The computer program product of claim 13, further comprising logic instructions stored on a tangible computer readable medium which, when executed by a secure controller, configure the secure controller to:
establish a secure channel between the secure controller and at least a portion of the display device; and
generate and presents a keyboard on the portion of the display device;
present a sequence of characters for the user to select on the keyboard; and
detect one or more cursor positions in response to the sequence of characters.

17. The computer program product of claim 16, wherein the cursor position corresponds to an input from at least one of a mouse click, a touch pad, a keyboard, or a touch screen.

18. The computer program product of claim 13, further comprising logic to:
establish a secure channel between the secure controller and at least a portion of the display device; and
generate and present a keyboard on the portion of the display device;
present a sequence of characters for the user to select on the keyboard; and
detect one or more key strokes in response to the sequence of characters.
